(19) United States
(12) Patent Application Publication
(10) Pub. No.: US 2007/0067527 A1
(43) Pub. Date: Mar. 22, 2007

(54) Data transfer bus system connecting a plurality of bus masters

(75) Inventor: Hiroshi Saitoh, Saitama (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/507,028

(22) Filed: Aug. 21, 2006

(30) Foreign Application Priority Data
Aug. 26, 2005 (JP) 2005-245411

(51) Int. Cl. G06F 13/00

(52) U.S. Cl. 710/110

(57) ABSTRACT

A data transfer bus system is provided which is able to carry out effective processing of interrupt. To an AHB (Advanced High performance Bus) of an AMBA (Advanced Micro-controller Bus Architecture) system, connected are an AHB bus interface connected to an ARM CPU, an AHB bus arbiter, an AHB-APB bridge, a high-performance peripheral device and a bus request priority determining circuit. Further, to the AHB-APB bridge, a timer and a UART device, etc., are connected via the peripheral bus (APB). The interrupt controller to which interrupt request signals are inputted outputs an interrupt signal to the ARM CPU and the bus request priority determining circuit, and decides whether to generate the bus request sent from the high-performance peripheral device, according to the priority ranking of the interrupt and the bus request.

### BACKGROUND FOR THE INVENTION

1. Field of the Invention

The present invention relates to a data transfer bus system operating in computer systems.

2. Description of the Background Art

As the typical data transfer bus system, the AMBA (Advanced Micro-controller Bus Architecture) system defined by ARM (Advanced RISC Machines) Ltd, is well known. The AMBA system has two main buses, the one is an advanced high performance bus (AHB), and the other one is an advanced peripheral bus (APB) for moderate performance. As the standard, the AHB bus is a main memory bus, and the AMBA system is provided with a random access memory (RAM) and a read-only memory (ROM).

In the basic AMBA system definition, if a high-performance peripheral device that transfers a large amount of data is required, this peripheral device is also placed on the AHB bus.

The standard AMBA system comprises two main buses, the one is the AHB bus and the other one is the APB bus. The AHB bus is the main memory bus that couples an ARM CPU (Central Processor Unit) to a random access memory (RAM) and a read-only memory (ROM) via an AHB bus interface.

In this basic system, if a high-performance peripheral device that transfers a large amount of data is required, this high-performance peripheral device is also placed on the high performance AHB bus.

The arbitration of bus access right between two masters, i.e. an ARM CPU and a high-performance peripheral device, is carried out by an AHB bus arbitrator.

For example, when the high-performance peripheral device obtains the access right to the AHB bus and accesses to each slaves as the master, the high-performance peripheral device initially sends a bus request signal (HBUSREQ) to the AHB bus arbiter. After receiving an acknowledgment signal (HGRANT), the high-performance peripheral device implements its access to each slaves. The AHB bus arbiter controls the access to various slave devices via the AHB bus decoder and select lines.

Use of a second bus for isolation from the advanced high performance bus (AHB) is proposed in order to use a single arbiter. The second bus is called as an advanced peripheral device bus (APB). The APB bus operates in the same fashion as the AHB bus. The APB bus is connected to the AHB bus via an AHB-APB bus bridge. The AHB-APB bus bridge is a slave device placed on the AHB bus. All moderate performance peripheral devices, such as a UART (Universal Asynchronous Receiver Transmitter) device and a timer, etc., are placed on the peripheral device bus.

Further, each of the interrupt request signals (INTREQ) generated by the UART and the timer, etc., is notified to an interrupt controller that determines the interrupt priority, and is, after the priority determination has been done, sent in the form of interrupt signal (CPUINT) to the ARM CPU that carries out the interrupt processing.

A feature that defines the bus arbiter of the AHB bus used in the AMBA system is disclosed in U.S. Pat. No. 6,859,852.

However, by placing the high-performance peripheral device on the AHB bus, when the high-performance peripheral device is controlling the AHB bus, meanwhile the APM CPU is not able to carry out its processing. For the interruption by the UART or the timer, etc., immediate response and processing by the ARM CPU are especially desired. It might thus be a problem that when bus requests by the high-performance peripheral device are generated frequently, the ARM CPU cannot accept any interrupt by the peripheral devices such as UART or a timer, etc., because the bus request priority is higher than the interrupt request priority. At a result, the system cannot operate normally.

Further, if a certain period of time is set as a bus request interval to accept interrupt, such setting might decrease the system performance to cause another problem.

In the prior art, as described above, the system is not able to allow the bus access easily to the low priority request, so that it is difficult to carry out effective processing.

### SUMMARY OF THE INVENTION

It is an object of the present invention to provide a data transfer bus system that is able to carry out effective processing of interrupt.

In a data transfer bus system that interconnects plurality of bus masters, the system of the present invention comprises a first controller acting as a dominant main bus master of the plurality of bus masters and carrying out data transfer, data reception and slave control, a data bus connected to a first controller, a second controller acting as another bus master of the plurality of bus masters connected to the data bus except the dominant bus master and carrying out data transfer, data reception and slave control, a bus arbiter that accepts a bus request signal of the first controller and the second controller and then grants either controller bus master right, and a priority determining circuit that determines the priority of the bus master right of the second controller. The priority determining circuit comprises a register that accepts a bus request signal from the second controller and a plurality of interrupt signals from peripheral devices and decides the priority for the plurality of interrupt signals, and a determining circuit that is operative in response to register information to determine priority of the bus request signal from the second controller and plurality of interrupt signals from the peripheral devices for setting the priority to determine whether to notify the bus arbiter of the bus request signal of the second controller.

According to the invention, by providing the priority determining circuit between the second controller and the bus arbiter, it is possible for the processing of interrupt to precede when bus request signals are generated frequently by the second controller. Therefore, solving the problem arisen when the bus request's priority is higher than the interrupt request's priority, the normal system performance is assured.

Furthermore, by providing a priority determining circuit that decides priority individually to the bus request and each interrupt request signal, it is possible to generate a bus request from the second controller when interrupt processing is being done, and it is also possible for the higher priority interrupt processing to precede the bus request signals frequently generated by the second controller. Thus, the system performance is more improved.

### BRIEF DESCRIPTION OF THE DRAWINGS

The objects and features of the invention will become more apparent from consideration of the following description taken in conjunction with the accompanying drawings in which:

FIG. 1 is a schematic block diagram showing an embodiment of an AMBA (Advanced Micro-controller Bus Architecture) system in accordance with the present invention;

FIG. 2 is a schematic block diagram showing one internal configuration of a bus request priority determining circuit included in the embodiment shown in FIG. 1;

FIG. 3 is a schematic block diagram, similar to FIG. 1, showing an alternative embodiment of an AMBA system in accordance with the invention; and

FIG. 4 is a schematic block diagram, like FIG. 2, showing an alternative internal configuration of a bus request priority determining circuit included in the alternative embodiment shown in FIG. 3.

### DESCRIPTION OF THE PREFERRED EMBODIMENTS

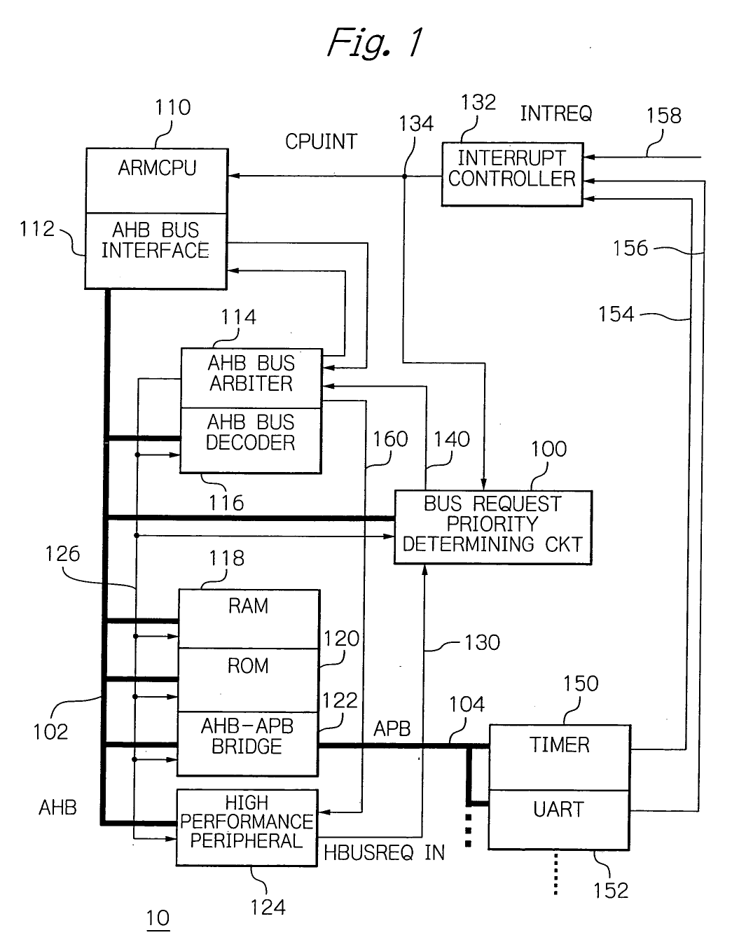

In the following, a preferred embodiment of the data transfer bus system according to the invention will be described in detail with reference to the accompanying drawings. The embodiments of the data transfer bus system according to the invention are applied, for example, to an AMBA (Advanced Micro-controller Bus Architecture) system defined by the ARM Ltd. FIG. 1 show an AMBA system 10 which includes a bus request priority determining circuit 100 is added. Elements not directly relating to understanding the invention are omitted from the figures and description.

With reference to FIG. 1, the AMBA system 10 includes an advanced high performance bus (AHB) 102 as a main memory bus and a moderate performance peripheral bus (APB) 104. As a standard system, the AHB bus 102 is the main memory bus, and the AHB bus 102 interconnects an AHB bus interface 112 connected to an ARM CPU (Central Processor Unit) 110, an AHB bus decoder 116 connected to an AHB bus arbiter 114, a RAM (Random Access Memory) 118, a ROM (Read-Only Memory) 120, an AHB-APB bridge 122, a high-performance peripheral device 124 which transfers a large amount of data and the bus request priority determining circuit 100. To the AHB arbiter 114, AHB bus decoder 116, RAM 118, ROM 120, AHB-APB bridge 122, high-performance peripheral device 124 and bus request priority determining circuit 100, connected is a select line 126.

Further, the AHB-APB bridge 122 is connected to a timer 150 and a UART device 152 via the peripheral bus (APB) 104. The timer 150 and the UART device 152 output interrupt request signals (INTREQ) to an interrupt controller 132 described below over signal lines 154 and 156, respectively.

Both of the ARM CPU 110 and high-performance peripheral device 124 play the role of master devices, and the bus access right between them is arbitrated by the AHB bus arbiter 114. Both of the ARM CPU 110 and high-performance peripheral device 124 have control functions for data transfer, data reception and slave control.

For example, when the high-performance peripheral device 124 is granted AHB access right as the master device and thus accesses the slaves, the high-performance peripheral device 124 sends a bus request signal (HBUSREQIN) to the bus request priority determining circuit 100 on the signal line 130. The bus request priority determining circuit 100 to which priority ranking of various interrupts and bus requests is set by software in advance determines the priority of a bus request sent from the high-performance peripheral device 124 according to the priority ranking, and decides whether to output the bus request sent from the high-performance peripheral device 124.

To the bus request priority determining circuit 100 and ARM CPU 110, an interrupt signal (CPUINT) is supplied from the interrupt controller 132 over signal line 134. To the interrupt controller 132, above-described interrupt request signals (INTREQ1 and INTREQ2) are inputted over signal lines 154 and 156 respectively, and also an interrupt request signal (INTREQ) from an external device, not shown, are inputted over a signal line 158. When the ARM CPU 110 is supplied with the interrupt signal (CPUINT), the ARM CPU 110 carries out the interrupt processing.

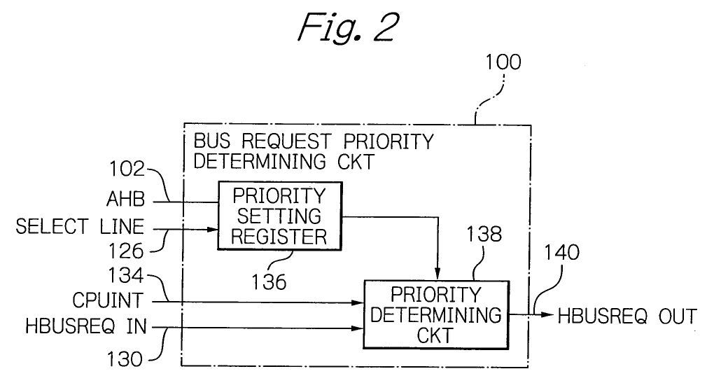

FIG. 2 shows an internal configuration of the bus request priority determining circuit 100. As shown in FIG. 2, the bus request priority determining circuit 100 has a priority setting register 136 which is accessible from the ARM CPU 110 over the AHB bus 102 and select line 126, and a priority determining circuit 138 which is connected to the register 136 and includes reservation logic to reserve the bus request signal (HBUSREQIN) outputted from the high-performance peripheral device 124. The priority determining circuit 138 outputs the bus request signal (HBUSREQIN) which reflects its determination result as the output of the bus request priority determining circuit 100.

Referring back to FIG. 1, the bus request priority determining circuit 100 has its output interconnected to the AHB bus arbiter 114. The AHB bus arbiter 114 carries out arbitration in response to the bus request signal (HBUSREQOUT) supplied from the bus request priority determining circuit 100 over the signal line 140.

The high-performance peripheral device 124 receives an acknowledgement signal (HGRANT) sent from the AHB bus arbiter 114 over a signal line 160, and thereafter makes access to the slave devices. Also, the AHB bus arbiter 114 controls access to various slave devices through the AHB bus decoder 116 and over the select line 126.

In the AMBA system 10, the APB bus 104 operates in the same manner as the AHB bus 102. The APB bus 104 is connected to the AHB bus 102 through the AHB-APB bridge 122. The AHB-APB bridge 122 is a slave device of the AHB bus 102. Every moderate performance peripheral device, such as the timer 150 and UART device 152, etc., is interconnected to the APB bus 104.

Next, the operation of AMBA system 10 having the above-described configuration in the embodiment of the invention will be described. Signals are specified by the reference numerals of connections on which they are conveyed. First of all, the priority setting register 136 shown in FIG. 2 has its value set in such a fashion that, whenever it is accessible from the ARM CPU 110 by a control signal 126 or over the AHB bus 102, the value is set to logical “1” when it is desired for an interrupt from the ARM CPU 110 precede a bus request (HBUSREQIN) from the high-performance peripheral device 124 and to logical “0” when it is desired for the bus request to precede the interrupt.

In this case, for example, if bus access is not granted yet after a predetermined period of time has passed since the interrupt request signal is generated, the priority setting register 136 changes its value from “0” to “1”. Then, after the interrupt processing has finished, the priority setting register 136 may return its value from “1” to “0”. In order to establish the predetermined period of time, it is preferable to provide a monitor circuit which starts its counting at the timing of generation of the interrupt request signal and updates the value set in the priority setting register 136 in response to its count having reached a predetermined value.

When logical “0” is set in the priority setting register 136, the priority determining circuit 138 lets the bus request (HBUSREQIN) pass through it and makes the bus request (HBUSREQOUT) enable logical “1”, no matter how an interrupt is generated or not. In other words, in this case, the bus request priority determining circuit 100 outputs the significant bus request (HBUSREQOUT) to the AHB bus arbiter 114.

When logical “1” is set in the priority setting register 136, the priority determining circuit 138 operates as follows. First, when no interrupt is generated but the bus request (HBUSREQIN) has become enable “1”, then the bus request (HBUSREQOUT) is rendered enable “1” to be sent to the AHB bus arbiter 114.

Further, if an interrupt is generated when the bus request (HBUSREQOUT) is enable “1”, the priority determining circuit 138 makes immediately the bus request (HBUSREQOUT) disable “0”, and ceases the bus request to the AHB bus arbiter 114.

If the bus request (HBUSREQIN) has become enable “1” when any interrupt is already generated, the priority determining circuit 138 keeps the bus request (HBUSREQOUT) disable “0” and does not output the bus request to the AHB bus arbiter 114.

According to the illustrative embodiment as shown in and described with reference to FIGS. 1 and 2, by providing the bus request priority determining circuit 100 between the high-performance peripheral device 124 and the AHB bus arbiter 114, it is possible for the interrupt processing to precede when bus request signals are generated frequently by the high-performance peripheral device 124. Therefore, solving the problem arisen when the bus request's priority is higher than the interrupt request's priority, the normal system performance is assured.

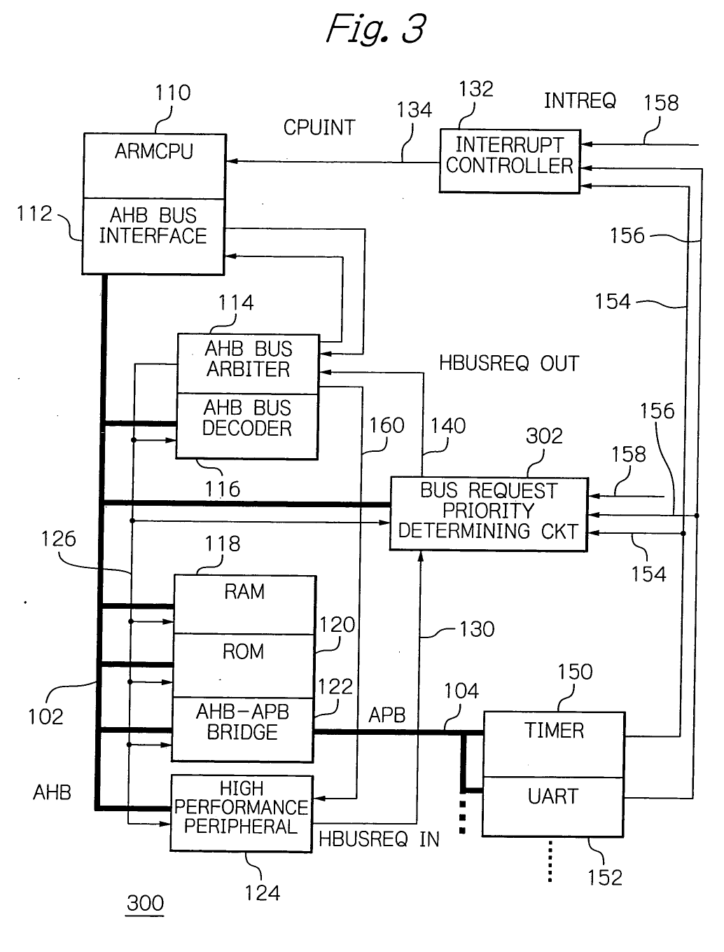

In the following, an alternative embodiment of the data transfer bus system will be described according to the invention with reference to FIG. 3, which specifically shows the alternative embodiment of AMBA system 300 to which the present invention is applied. The AMBA system 300 of the alternative embodiment may have the same configuration as the AMBA system 100, FIG. 1, except for a bus request priority determining circuit 300 which is, instead of the bus request priority determining circuit 100, adapted for receiving a plurality of interrupt request signals (INTREQ1, INTREQ2 and INTREQ3) applied over signal lines 158, 156 and 154, respectively, rather than the interrupt signal (CPUINT 134) from the interrupt controller 132.

In the illustrative embodiment shown in FIG. 1, either of the bus request and interrupt signal precedes the other. However, there may be such a case that a bus request is generated by an interrupt used as trigger. Therefore, the alternative embodiment shown in FIG. 3 is adapted to make it possible to grant priority for plural interrupt signals and a bus request.

As seen from FIG. 3, the bus request priority determining circuit 302 of the alternative embodiment shown in FIG. 3 may be the same as the bus request priority determining circuit 100 of the illustrative embodiment shown in FIG. 1 except that the former 302 is adapted to receive interrupt request signals (INTREQ1, INTREQ2 and INTREQ3) applied and have its output 140 interconnected to the AHB bus arbiter 114.

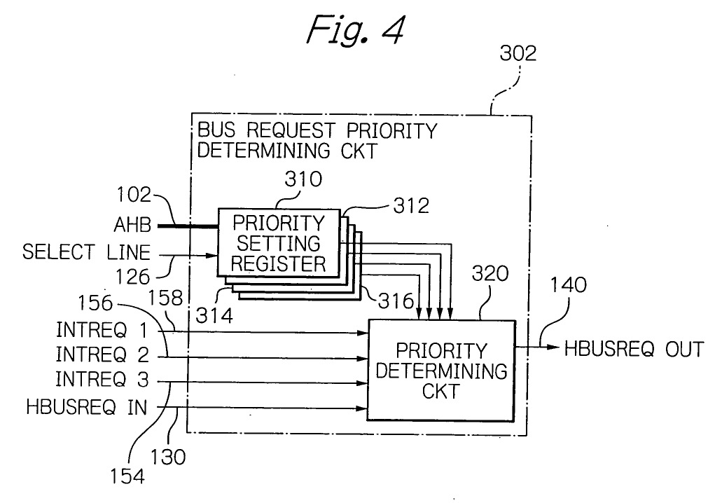

FIG. 4 shows an internal configuration of the bus request priority determining circuit 302. As shown in the figure, the bus request priority determining circuit 302 has plural priority setting registers 310 to 316 which are connected to the AHB bus 102 and select line 126, respectively. Those plural priority setting registers 310 to 316 assign priority individually to the interrupt request signals (INTREQ1, INTREQ2 and INTREQ3) and the bus request (HBUSREQIN) outputted from the high-performance peripheral device 124. In this embodiment, since there are four signal lines to set their priority, the four priority setting registers 310 to 316 are provided. It is also possible to set values indicating a priority level from “priority 0” meaning the lowest priority to “priority 3” meaning the highest priority. In the following, the operation will be described, for example, when “priority 0” is assigned to the interrupt request signal (INTREQ2), “priority 1” is assigned to the bus request signal (HBUSREQIN) and “priority 3” is assigned to the interrupt request signal (INTREQ3). That is, the priority increases in the order of INTREQ2, HBUSREQIN and INTREQ3.

In this case, because the bus request is given higher priority than the interrupt request signal (INTREQ2), the priority determining circuit 320 can generate the bus request signal (HBUSREQOUT) (enable “1”) when the interrupt processing is being done for the interrupt request signal (INTREQ2). Furthermore, when the bus request (HBUSREQOUT) is enable “1”, if the interrupt request signal (INTREQ3) having the higher priority is generated, the priority determining circuit 320 immediately makes the bus request (HBUSREQOUT) disable “1” to stop the bus request to the AHB bus arbiter 114.

As described above, according to the alternative embodiment, by providing the bus request priority determining circuit 302 for setting priority individually to the bus request and each interrupt signal, it is possible to generate the bus request from the high-performance peripheral device 124 when the interrupt processing is being done. Further, it is also possible for the higher priority interrupt processing to precede the bus request frequently generated by the high-performance peripheral device 124. Therefore, the system performance can be more improved than the illustrative embodiment shown in FIGS. 1 and 2.

The illustrative embodiments described above can be applied to any data system LSI (Large-Scale Integration) which includes such a data system typically as an AMBA system. Although the embodiments have been described for the system focused only upon one AHB bus master other than the CPU, the invention is also applicable to a system LSI having plurality of bus masters. For example, the number of sets of the priority setting registers 310 to 316 in the alternative embodiment may be increased corresponding to the number of bus masters. Also, the total number of the interrupt request signals (INTREQ) and bus request signal used in the alternative embodiment is not limited to four as in the embodiment shown in FIG. 4, but is possible to select a more number correspondingly to the plural interrupt signals. Therefore, the number of priority setting registers may be increased or decreased corresponding to the number of bus requests and the number of interrupt signals. Also, the levels of priority setting may not be limited by “priority 0 to 3” but increased or decreased if necessary. Further, if the bus request's priority and the interrupt's priority are the same as each other, the priority setting may be implemented optionally as occasion demands, so that either of them precedes the other.

The entire disclosure of Japanese patent application No. 2005-245411 filed on Aug. 26, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope of the present invention.

What is claimed is:

1. A data transfer bus system connecting a plurality of bus masters, comprising:
a first controller acting as a dominant bus master of the plurality of bus masters for carrying out data transfer, data reception and slave control;
a data bus connected to said first controller;
a second controller connected to said data bus and acting as another bus master of the plurality of bus masters except the dominant bus master for carrying out data transfer, data reception and slave control;
a bus arbiter for accepting a bus request signal of said first controller and said second controller to grant bus master right either of said first and second controllers; and
a first determining circuit for determining the priority of the bus master right of said second controller;
said first determining circuit comprising:
a register for accepting a bus request signal from said second controller and a plurality of interrupt signals from peripheral devices to decide the priority for the plurality of interrupt signals; and
a second determining circuit responsive to register information for setting the priority for determining the priority between the bus request signal from said second controller and the plurality of interrupt signals from the peripheral devices, and determining whether to notify said bus arbiter of the bus request signal of said second controller.

2. The bus system in accordance with claim 1, wherein said first controller comprises an interrupt controller for outputting the interrupt signal,
said first determining circuit being operative in response to the bus request signal from said second controller and the interrupt signal to determine the priority.

3. The bus system in accordance with claim 1, wherein said first determining circuit is operative in response to the bus request signal from said second controller and the plurality of interrupt signals from the peripheral devices to determine the priority.
